(19) United States
(12) Patent Application Publication
(10) Pub. No.: US 2019/0191635 A1
(43) Pub. Date: Jun. 27, 2019

(54) CANOPY DEVICE

(71) Applicant: Lock Antriebstechnik GmbH, Ertingen (DE)

(72) Inventors: Berry ZUIDERWIJK, BS Honselersdijk (NL); Ulrich NEUBRAND, Ertingen (DE)

(73) Assignee: Lock Antriebstechnik GmbH, Ertingen (DE)

(21) Appl. No.: 15/962,036

(22) Filed: Apr. 25, 2018

(30) Foreign Application Priority Data
Dec. 21, 2017 (DE) 20 2017 107 842.6

(51) Int. Cl. A01G 9/16

(52) U.S. Cl. CPC A01G 9/16; E04H 15/36

(57) ABSTRACT

A canopy device including a drive unit for moving a canopy material and at least two girders that extend in a movement direction of the canopy material and which are spaced apart from each other transversely to the movement direction of the canopy material. The canopy material can be moved from an opened actuating state to various actuating states between the girders. The drive unit is fixed in position and includes a transmission arrangement and an actuating element able to move along a girder, which are coordinated such that a driving action can be transmitted from the drive unit to the actuating element. The actuating element is designed for a connection to the canopy material and is coupled to a gear wheel of the transmission arrangement, which is drivable by the drive unit. The gear wheel interacts with a tooth contour formed along the girder.

This application claims the benefit under 35 USC § 119(a)-(d) of German Application No. 20 2017 107 842.6 filed Dec. 21, 2017, the entirety of which is incorporated herein by reference.

### FIELD OF THE INVENTION

The present relates to a canopy device for providing a canopy made from a flexible canopy material, which can be moved with a device into various actuating states.

### BACKGROUND OF THE INVENTION

Canopy devices for providing a temporary cover, in particular, such as a protective roof or a canopy for private or commercial applications, as in industry or agriculture, are known in many different forms. For example, in farming, canopies are used, in particular, for crops or plantations to protect the plants, in order to achieve secure and large harvests or to protect the plants against harm or unwanted influences from the outside or in order to minimize the migration of plant treatment and protection chemicals into the surroundings. Furthermore, the canopy provides a protection especially against climate factors due to light and temperature or sun, rain, hail, storms and/or snow. The canopies can be used with greenhouses and the like or out in the open, making use of protective netting or protective sheets for the covering, for example.

The drawback to such canopy devices is that they are economically costly and cannot always be used specifically enough to the application.

### SUMMARY OF THE INVENTION

The problem which the present invention proposes to solve is to provide an alternative canopy device especially for plantations, which is technically and economically improved in its use.

The present invention starts from a canopy device, especially one for plants, animals, or objects, such as a sheetlike plant canopy. The canopy device serves for providing a canopy made from a flexible canopy material, which can be moved with the device into various actuating states, wherein the device has a drive unit for moving the canopy material into the different actuating states, wherein the device comprises at least two girders, which define a canopy region and extend in a movement direction of the canopy material and which are spaced apart from each other transversely to the movement direction of the canopy material, wherein the canopy material can be moved from an opened actuating state of the canopy to various actuating states of the canopy material between the at least two girders, so that the canopy material spans at least one section between the girders.

The girders are preferably formed of narrow elongated metal profiles and mechanically rigid elements and they are fixed in position and statically stable. The girders preferably dictate a roof shape of the canopy region or a region which can be covered by the canopy material.

Preferably, the two or more girders are similar, preferably identical, in configuration.

The girders may extend by at least one end into the region of a ground surface, such as a field surface or a cultivation surface. However, the girders are preferably spaced away from the ground, for example placed on a ground or base structure underneath the girders. The base structure in one simple instance may be formed from props and/or posts, especially with no sheetlike, ground-supported wall elements. The base structure may comprise, for instance, a truss structure.

As canopy material, use is preferably made of a flexible single or multiple-ply material made from a transparent and/or at least partly light-blocking plastic or composite material. The canopy material comprises, for example, a closed sheet and/or a flexible perforated structure such as a net or a perforated sheet.

The drive unit preferably comprises an electric drive or electric motor, especially a slow-running one equipped with a self-locking worm gear and integrated end switch. Preferably, the drive unit is maintenance-free and suitable for outdoor operation.

Depending on the actuating state of the canopy, the canopy device can establish a completely closed canopy, especially one completely closed on top, for the particular canopy region situated underneath, or a situation which is completely clear or open on top.

The crux of the present invention lies in the fact that the drive unit is fixed in position, wherein the device comprises a transmission arrangement and an actuating element able to move along a girder, which are coordinated such that a driving action can be transmitted from the drive unit to the actuating element, wherein the actuating element is designed for a connection to the canopy material and wherein the actuating element is coupled to a gear wheel of the transmission arrangement which is drivable by the drive unit, wherein the gear wheel interacts with a tooth contour formed along the girder. The girders are fixed in position and the gear wheel moves relative to the corresponding girder. Preferably exactly one gear wheel or always the same gear wheel can move back and forth along a particular longitudinal section of the tooth contour.

With the tooth contour on the girder and the intermeshing gear wheel, a gear wheel drive is realized which is robust and form-fitting and which works reliably with no slippage. This is advantageous in regard to an exact movement and torque transmission.

In the following, in place of the term gear wheel we shall also use the term pinion synonymously. The gear wheel is preferably made from a metal material as a spur gear or cylindrical gear.

The transmission arrangement serves for the transmission of a driving action to the actuating element or a driving torque from the drive unit to the gear wheel. The gear wheel can be placed in rotation by the drive unit and the transmission arrangement optionally in a first rotary direction or a second rotary direction about an axis of rotation of the gear wheel.

For this, an executive control unit or e.g. a regulating or controlling unit of the canopy device with a computer unit is provided, which controls the drive unit. With the driven rotation of the gear wheel and the forced translatory movement of the gear wheel along the girder tooth contour occurring during the driving process, the axis of rotation of the gear wheel likewise moves in translation with or follows the axis of rotation along the girder. Accordingly, there is a superimposed translatory and rotary movement of the gear wheel. Preferably, the gear wheel is connected to the actuating element in the area of the axis of rotation or a gear wheel component forming the axis of rotation. For example, the actuating element is shaped as a clamp, grasping the girder on the top side.

With the canopy device according to the present invention, an economically and technically advantageous system can be provided, made up of a few standard components and individually adaptable to different application instances. With the combination of the movable gear wheel or pinion on the stationary girder tooth contour, a forced movement guidance is preferably realized, with which the pinion and thus the actuating element and a connected section or edge of the canopy material can be placed precisely in a desired position between the girders. Each position of the actuating element along the girder can be reached with the driven pinion. With the stopping or shutting off of the drive unit upon reaching the desired position of the pinion or the actuating element on the girder, the pinion is secured with self-locking on the tooth contour. Further movement of the pinion can only occur by the drive unit. The respective degree of canopy of the canopy device or the canopy material is precisely dictated by the corresponding actuating state of the actuating element and can be changed at any time or moved to any other actuating state or value between “100% canopy” and “0% canopy”.

Furthermore, the system is mechanically stable. A corresponding tooth contour is formed on at least one of the girders, preferably along all of the girders, and a corresponding gear wheel can move on each girder intermeshing with the tooth contour. A pinion tooth contour present on the outside of the gear wheel and the tooth contour on the girder are coordinated such that the gear wheel and the tooth contour on the girder intermesh exactly and with no play. Furthermore, the gear wheel and the girder tooth contour are designed to be intermeshing with little noise and little wear. The girder with the tooth contour comprises, for example, a curved toothed rack. The toothed rack is formed preferably from galvanized or hardened steel.

Moreover, it is advantageous that the transmission arrangement comprises a drive shaft drivable with the drive unit, which is mounted fixed in position. The drive shaft enables a transmission of torque in a space-saving and simple manner. Furthermore, the drive shaft can be lengthened almost at will. The drive shaft is preferably made of a metal material. For example, the drive shaft is a hollow or solid profile, with round or polygonal outer shape, in particular a hollow round profile with cylindrical outer shape. Depending on the control system of the drive unit, the drive shaft rotates either left or right, or the drive shaft stands still, blocking an unwanted further rotation.

According to one advantageous modification of the present invention, several actuating elements can be driven at the same time with a single drive shaft. With the drive shaft, a number of pick-off points can be provided along the drive shaft for picking off a torque. In this way, a plurality of gear wheels and thus a plurality of actuating elements can be driven with a single or with a shared drive shaft. It is furthermore easily possible for all of the gear wheels driven with the shared drive shaft to turn in the same direction of rotation at the same time. With slight expense, it is also possible with precisely a single drive shaft, which can be a single piece or composed of several partial shafts, to turn many of the gear wheels in a first direction of rotation and the other gear wheels in the second or opposite direction of rotation.

Thus, two respective gear wheels can be moved in translation with the drive shaft in the same direction, which occurs along the respective girder tooth contour, or two gear wheels can be driven at the same time in translation in a respectively opposite direction or, for example, toward each other or away from each other. This is advantageous, for example, for a canopy with variable uses.

It is also advantageous when the transmission arrangement comprises a telescopic coupling. In this way, a distance change between the drive shaft and the gear wheel can be equalized, the change in distance being caused by the movement of the gear wheel along the girder tooth contour. With the co-rotating telescopic coupling, a mechanically stable transmission of torque is possible. The telescopic coupling is economically advantageously and preferably a standard component available in a number of different design sizes. Preferably, the telescopic coupling comprises a tubular arrangement, such as a rectangular tube with easy-running length compensation. The telescopic coupling, for example, may comprise a rectangular aluminium tube with two universal joints made of steel. It is also advantageous for all parts to have a stainless steel design for use outdoors. Furthermore, it is advantageous for the telescopic coupling to be designed as a telescopic articulated coupling, especially with two universal joints.

It is furthermore advantageous when the transmission arrangement comprises a reversing gear. In this way, drive torques and rotary motions can be transmitted at an angle in both directions of rotation of the drive shaft. The reversing gear preferably serves for an angled drive connection between the drive shaft and the telescopic coupling.

The reversing gear is preferably designed as a 90-degree reversing gear. The reversing gear, for example, has a cast iron housing and a crown wheel and a spur gear, each made of steel, while the housing is sealed, making possible an outdoor use.

Advantageously or preferably, a transverse shaft of the transmission arrangement is present between the telescopic coupling or its upper universal joint and the gear wheel, on which the gear wheel sits firm against rotation and turns along with the driven transverse shaft. It is not ruled out to have another or a direct rotary connection between the telescopic coupling and the gear wheel.

An advantageous modification of the present invention is characterized in that a connection segment engages each time at several positions of the drive shaft, spaced apart from each other in the longitudinal direction of the drive shaft, thereby establishing a driving connection to a corresponding gear wheel. The connection segment preferably comprises the reversing gear.

In this way, several gear wheels may be driven at any desired points of the drive shaft or several gear wheels may be driven with precisely a single drive shaft and thus several actuating elements can be moved. Each gear wheel can be driven, e.g., by its own connection segment, which provides for example a partial drive train. Preferably, each driving segment between the drive shaft and the respective gear wheel comprises a reversing gear, a telescopic coupling and a transverse shaft. Preferably, all respective reversing gears, telescopic couplings and transverse shafts of the canopy device are each identical. Furthermore, preferably all girders are identical to each other, which is advantageous economically and in terms of installation. Accordingly, it is preferable for the canopy device to comprise precisely one drive shaft and precisely one drive unit driving it. In the case of larger canopy devices, for mechanical reasons or for design reasons, it may be advisable to provide several drive units and/or several drive shafts.

Another advantage lies in the fact that at least two gear wheels, spaced apart from each other in the direction transverse to the movement direction of the canopy material, are linked together firm against rotation by a connection element of the transmission arrangement. The rotating connection element is preferably the transverse shaft. Since the drive shaft or its longitudinal axis is oriented preferably in the direction of movement or parallel to the direction of movement of the canopy material, the at least two gear wheels are connected to the transverse shaft transversely to the drive shaft. With the transverse shaft, the canopy can be extended almost at will in the direction of the transverse shaft or transversely to the drive shaft or the respective row of the canopy can be so extended. With the transverse shaft and the gear wheels fastened to it, each time a gear wheel can be driven in rotation and moved along the several girders of the canopy row, separated from each other along the length of the transverse shaft and standing perpendicular to the transverse shaft.

The first gear wheel of the row, which is driven by the drive unit across the drive shaft, the reversing gear, the telescopic articulated coupling and the transverse shaft, can be connected across the further length of the transverse shaft to at least one additional gear wheel, which experiences a driving torque across the transverse shaft. In this way, the additional gear wheel is driven at the same time as the first gear wheel and with the same direction of rotation. Several additional gear wheels can be secured to the transverse shaft and be driven across the transverse shaft, the several gear wheels being present along the length of the transverse shaft corresponding to the spacing of the girders between one another. The transverse shaft rotates when driven and moves in translation along or in the longitudinal direction of the girder.

The transverse shaft extends preferably over the entire length of the row of the canopy, in order to reach all girders of a row. The transverse shaft's extension is accordingly preferably in the direction transverse to the direction of movement or from a first girder to a last girder of a canopy row.

Preferably, a corresponding gear wheel is present in a row of the canopy on each girder of the row along an angular range from the horizontal, which is dictated by a lowest point on the girder or the tooth contour, to the vertical, which is dictated by a highest point on the girder or the tooth contour. The canopy material, such as a flexible cover sheet, is thus received by the gear wheel with actuating element and able to move back and forth on each girder of a row of the canopy.

Since a girder preferably spans an angle of a quarter circle, there are preferably two quarter-circle girder sections present for the easier formation of the girder. A corresponding gear wheel can move along each quarter-circle girder section. For all quarter-circle girder sections which form a side or a half of the several girders of a row of the canopy, a corresponding transverse shaft is provided with the respective gear wheels.

If one considers a row of the canopy with a first transverse shaft and the corresponding gear wheels, a first side of the row or a first half-side of all girders can be covered with the canopy material.

With the other or second transverse shaft and the corresponding gear wheels and actuating elements present on the other side of the same canopy row, a cover material which can move there with or a movable cover sheet with the canopy material can cover the corresponding girder sections accordingly.

According to one advantageous modification, an actuating element is connected and coordinated with the canopy material such that the canopy material is compressible by a folding process during an opening process of the canopy.

In this way, a winding arrangement for the winding and unwinding of the canopy material can be omitted, which is advantageous because a corresponding winding device with a winding shaft is costly and complicated and is prone to failure, especially in the case of large areas being covered.

According to the present invention, the canopy material is advantageously unfolded almost by itself when the canopy is closed, with no further assisting device such as a winding device, and it folds together automatically or is gathered freely when the canopy is opened. No special arrangement is needed for the folding and unfolding of the canopy material. Instead, the canopy material by virtue of its material properties or its flexibility and its own weight folds up by itself when the canopy is opened, and when the canopy is closed it stretches out by itself, region by region, which is accomplished by pulling up on the covering material by the actuating elements.

The canopy material when folded becomes compressed and space-saving and is protected for example against the influence of the wind. The automatic folding up of the canopy material occurs by multiple layering of the canopy material. When the canopy is entirely open, the folded cover material is placed on a side bearing region of the eaves of the canopy.

During the reverse closing process of the canopy, the canopy material is unfolded and spread out solely by traction forces which are applied by the actuating element to the canopy material. In this process, narrow regions of the canopy material lie against a top or outer side of the respective girder or girder sections. The outer side of the girder is preferably designed flat or level for this, so that the canopy material can easily slide along it.

On the opposite side of the outer side of the girder, the tooth contour is present on the girder, i.e., an inside tooth contour is provided in particular. The actuating element is accordingly present preferably enclosing the girder section from above. This reliably prevents regions of the canopy material from getting jammed between the gear wheel and the tooth contour on the girder.

Another advantage of the present invention results from the fact that at least two actuating elements are provided on one girder, each actuating element being drivable by a corresponding transmission arrangement. The girder preferably comprises two girder sections, each with a gear wheel. One girder section belongs to a first half of a row of a canopy and the other girder section belongs to the second half of the row of the canopy. A first actuating element is present on a first side of the girder, e.g., on a first quarter-circle girder section of the girder, and a second actuating element is present on a second side or on a second quarter-circle girder section of the girder. The first and the second actuating element are each coupled to a gear wheel, which can be driven by a respective transmission arrangement. The two gear wheels move with different direction of rotation, in opposite directions along the girder, i.e., toward and away from each other, when both gear wheels are driven at the same time.

Preferably, all gear wheels of the canopy device are always driven at the same time and stand still at the same time, or all gear wheels are not driven at the same time or are halted at the same time. This makes possible a reliably functioning canopy device with a simple control system. When oppositely driven gear wheels are present, e.g., on both sides of a girder, they are preferably situated in the same relative position on the girder.

The preferably precisely one drive can advantageously be driven in on/off mode. When the drive is running, all gear wheels are equally driven and all gear wheels bring about the opening of the canopy or all gear wheels bring about the closing of the canopy in the same way and to the same degree. This minimizes a complicated control system, wrong operation, or system faults. Preferably by using simple elements of the canopy device, such as switches, it is automatically recognized when end positions of the gear wheels are reached when the drive is running, thus e.g., when the canopy is totally open or totally closed, so that a switching off of the drive unit occurs automatically, e.g., with the help of end switches.

Advantageously, the girder is fashioned as a curved longitudinal profile. Thus, the girder can withstand a large mechanical load with little material input and in a space-saving manner.

Each girder preferably comprises two girder sections, with a first end in the lengthwise direction and a second end, between which the girder section is formed straight in its longitudinal extension, seen from above, and curved from the side, preferably in the shape of a quarter circle.

According to a preferred modification of the present invention, the girder comprises a first girder section and a second girder section, wherein a corresponding first gear wheel is able to move along the first girder section and a corresponding second gear wheel is able to move along the second girder section.

Preferably, the first and the second girder section are each in the form of a quarter circle, so that precisely two gear wheels are present on the girder formed from the two girder sections along a half-circle or 180 degrees.

Preferably, a girder comprises two identical girder sections which are adjacent or joined in their upper end region, in the lengthwise direction. The two girder sections preferably form a quarter circle arc. In this way, a half circle girder can be formed easily from two girder sections.

The tooth profile is formed, in particular, without interruption or continuously on the girder sections. In this way, the gear wheel can move along the entire length of the girder section on them.

Finally, it is advantageous when several canopy rows are present, arranged alongside each other in the movement direction of the canopy material, each canopy row comprising several girders, spaced apart from each other transversely to the movement direction of the canopy material.

Preferably, two or more rows are present, each with two or more girders. A row consists preferably of several girders spaced apart evenly, e.g., at intervals of 2 metres. Preferably, girders of neighbouring rows are arranged flush.

Preferably, each girder is braced by respective lower ends of the respective girder sections in each case on a base structure.

The canopy device is preferably designed to be closing from bottom to top.

### BRIEF DESCRIPTION OF THE DRAWNGS

Further features and advantages of the present invention shall be explained more closely with the aid of an exemplary embodiment of the invention, represented schematically in the figures.

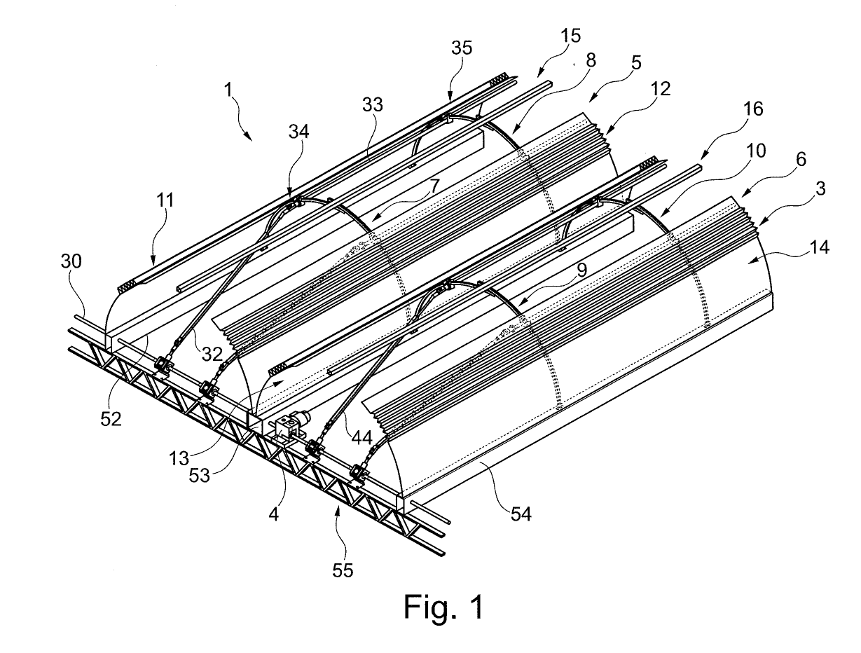

FIG. 1 a perspective partial view diagonally from above of a canopy device according to the present invention in the mounted state on a holder;

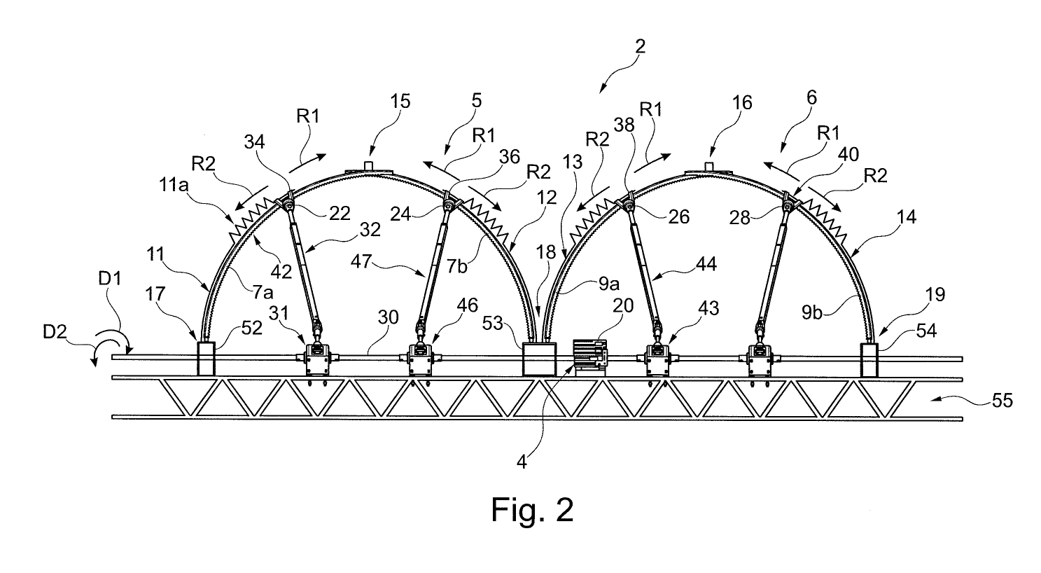

FIG. 2 is the front view of FIG. 1;

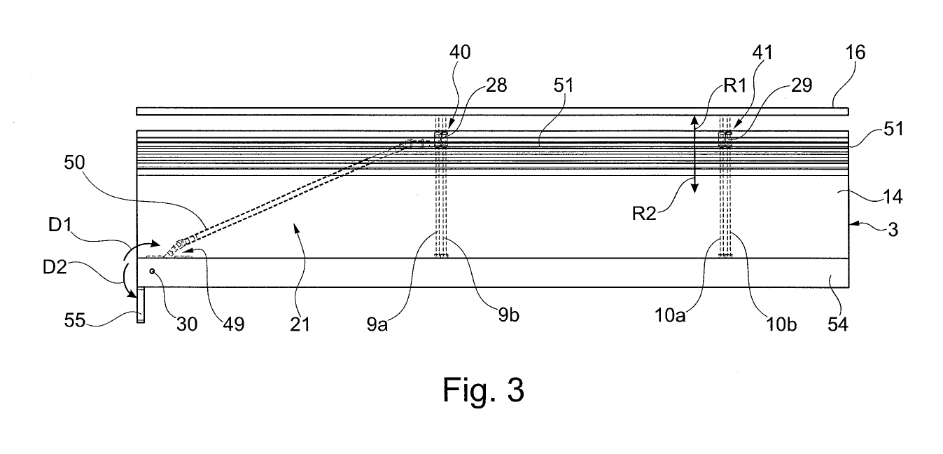

FIG. 3 is side view of FIG. 1; and

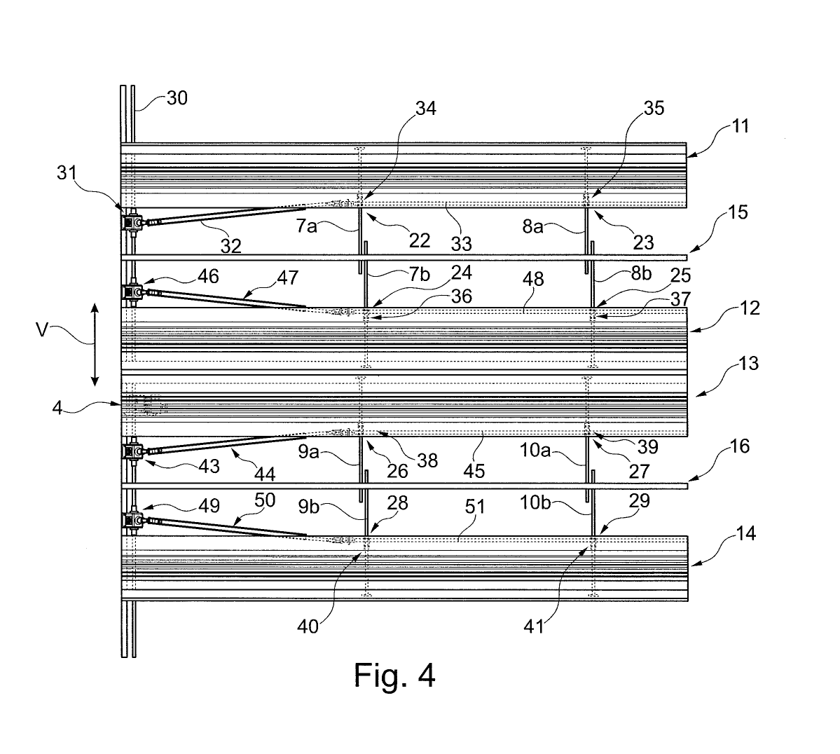

FIG. 4 is a top view of FIG. 1.

### DETAILED DESCRIPTION OF THE INVENTION

A canopy device 1 according to the present invention serves for providing a canopy 2 made from a flexible canopy material 3, such as an orchard canopy or hardening house for crops. Hardening houses serve, in particular, for temperature and light habituation, for example for perennial plants, for which the cultivation occurs in a covered area, after an alternation of various temperatures, from warm to cool. Such plants are planted, for example, in the autumn and need to survive a winter in order to bloom in spring.

With the canopy 2, a zone with a rectangular ground surface is temporarily housed or covered entirely or partially underneath the canopy 2. In FIGS. 1 to 4, the canopy 2 is for the most part closed or only opened somewhat in the upper region.

When the canopy 2 is entirely opened (not shown), the respective area is present without any canopy or free to the surroundings. The canopy material 3, such as a flexible, weatherproof, transparent sheet, can be moved with the canopy device 1 by motor or automation into different actuating states at will and in reversible manner.

The canopy device 1 comprises a drive unit 4 for moving the canopy material 3 into the different actuating states. The canopy device 1 comprises different regions, which in the example shown comprise a first row 5 and a second row 6, forming a tunnel-shaped or semicircular canopy when the canopy 2 is closed.

The two rows 5 and 6 are identical in construction and are oriented alongside each other and parallel to each other. The two rows 5 and 6 comprise two girders 7, 8 and 9, 10. The canopy material 3 comprises four striplike or rectangular cover sheets 11 to 14, wherein the cover sheets 11 and 12 belong to the first row 5 and the cover sheets 13 and 14 belong to the second row 6.

The girders 7-10 each comprise two girder sections, which are present parallel to each other and somewhat set off from one another. Accordingly, the girder 7 comprises the girder sections 7a and 7b, the girder 8 the girder sections 8a and 8b, the girder 9 the girder sections 9a and 9b and the girder 10 the girder sections 10a and 10b.

The cover sheets 11 and 12 can be stretched between the girders 7 and 8 and beyond each of them to the sides and can be moved from a ridge area 15 of the first row 5 in each case in the direction of movement V (see FIG. 4) or R2 to the outside and downward as far as the outer eaves 17 and inner eaves 18. The cover sheets 11 and 12 are laid in folds and laid together or gathered compactly. In the Figures, the segment of the cover sheet 11 not lying flat or still gathered and the additional cover sheets 12 to 14 are not shown realistically, but rather highly schematized in the form of a harmonica.

The cover sheets 13 and 14 of the second row 6 can be stretched accordingly between the girders 9 and 10 and beyond each of them to the sides and can be moved from a ridge area 16 of the second row 6 in each case in the direction of movement V or R2 to the outside and downward as far as the outer eaves 19 and the inner eaves 18.

For the movement of the canopy material 3 or the respective cover sheets 11-14, the canopy device 1 comprises the drive unit 4, such as an electric motor 20, and a transmission arrangement 21, which acts between the drive unit 4 and eight identical gear wheels 22 to 29, in order to drive each of the gear wheels 22 to 29 optionally in rotation in one direction or the other.

The transmission arrangement 21 comprises a drive shaft 30 for a drive connection between the drive unit 4 and the gear wheels 22-29. The drive shaft 30 is driven in rotation by the drive unit 4.

From the drive shaft 30, four partial drive trains of the transmission arrangement 21 branch off.

A first partial drive train, explained more closely in the following, and producing the driving of the gear wheel 22, comprises a reversing gear 31, engaging with the drive shaft 30, a telescopic coupling 32, connected to the reversing gear 31 and preferably designed as a telescopic articulated coupling, and a transverse shaft 33 connected to the telescopic coupling 32, on which the gear wheel 22 is mounted, firm against rotation. A takeoff shaft of the reversing gear 31 stands preferably at an angle of around 45 degrees to the horizontal, for space reasons, so that the telescopic coupling 32 is also oriented about this angle range or somewhat more steeply or shallow, depending on the particular actuating state.

By rotation of the drive shaft 30, the telescopic coupling 32 is driven in rotation by the reversing gear 31, designed as a 90-degree reversing gear, and thus the transverse shaft 33 with the gear wheel 22 is driven in rotation. The telescopic articulated coupling 32 automatically provides distance and length equalization in its longitudinal direction and comprises at each end a universal joint, so that a spatial change in position of the transverse shaft 33 can be equalized or adapted to the positionally firm reversing gear 31.

The gear wheel 22 rotating with the transverse shaft 33 meshes with its circumferential tooth contour by a tooth contour 42 formed to fit the tooth contour on the gear wheel 22, which is present at the bottom side of the girder section 7a. In this way, depending on the direction of rotation D1 or D2 of the drive shaft 30, the gear wheel 22 is driven clockwise or anticlockwise, so that the gear wheel 22 and an actuating element 34 arranged on it or coupled to the gear wheel 22 can move along the girder section 7a upward and inward in the direction R1 or downward and outward in the direction R2. Advantageously, there are no buckling areas in the movement, since the girder section 7a is curved. The actuating element 34 is connected to the cover sheet 11 and accordingly moves the cover sheet 11 along, R1 being the closing direction of the cover sheet 11 and R2 the opening direction of the cover sheet 11.

The additional gear wheel 23 arranged firm against rotation on the transverse shaft 33 is in meshing contact with a tooth contour of the girder section 8a of the girder 8, formed corresponding to the tooth contour 42. In this way, the corresponding actuating element 35 and thus also the cover sheet 11 in this area is driven in motion in the closing direction R1 or in the opening direction R2. The transverse shaft 33, which rotates during the opening and closing of the cover sheet 11 and forms the axis of rotation of the gear wheels 22 and 23, at the same time carries out the translatory movement R1 or R2 together with the actuating elements 34 and 35 along the curved shape of the girder sections 7a and 8a.

Furthermore, in a corresponding manner, a corresponding actuating element 35 to 41 is coupled to each of the additional gear wheels 23 to 29, acting in correspondence with the actuating element 34 and being connected to the corresponding cover sheet 11-14 in each case.

The drive unit 4 can be switched at will between the on and off states, so that the cover sheet 11 and also the other cover sheets 12-14 can be brought at the same time into any given actuating state in agreement with the other cover sheets.

FIGS. 1 to 4 show a canopy 2 roughly closed by two thirds, wherein a gathered segment of the cover sheets 11-14 is shown schematically in zig-zag fashion. With the canopy device 1, a canopy 2 closing from the eaves 17-19 or from the bottom and a canopy 2 opening from the ridge areas 15, 16 or opening from the top is realized. In the state of the canopy 2 partly opened in the figures, the cover sheets 11-14 cover an angle range of around 60 degrees from their respective lower eaves-side longitudinal edge to their respective upper edge, pulled up in the direction of the respective ridge areas 15, 16, on the quarter-circle respective girder sections 7a, 7b to 10a, 10b of the girders 7-10. A remaining angle range up to the ridge area 15 or 16 or up to the vertical at 90 degrees along the girders 7-10 is clear or open to the surroundings. This clear area can still be closed with the cover sheet 11 by appropriate switching of the drive unit 4. All intermediate positions or intermediate actuating states between totally open canopy 2, when the cover sheet 11 is completely folded up at the eaves 17, and totally closed canopy 2, are possible by motor operation.

When the canopy is completely closed (not shown) or when the actuating state of the cover sheets 11-14 is completely closed, the entire area under the outstretched cover sheets 11-14, produced by the two tunnel arches according to the two rows 5 and 6 with the girders 7-10, is covered. The end faces of the canopy device 1 or of the two rows 5 and 6 are not affected by this.

The movement of the cover sheet 13 at the row 6 occurs simultaneously and identically to the cover sheet 11 as described above, wherein the cover sheet 13 acts corresponding to the cover sheet 11. Advantageous for this are the corresponding or identical components in operative connection with the drive shaft 30, namely, a reversing gear 43, a telescopic coupling 44, the gear wheel 26 with the actuating element 38 and a transverse shaft 45 with the other gear wheel 27 and the actuating element 39, wherein the upper edge of the cover sheet 13 engages with the actuating elements 38, 39. The gear wheels 26, 27 mesh, like the gear wheels 22, 23, with tooth contours which are present on the inside of each of the curved girders 9a, 10a.

Basically all girder sections 7a, 7b to 10a, 10b each have a tooth contour at the inner side.

The two corresponding cover sheets 12 and 14 of the rows 5 and 6 likewise function in the same way and are moved by a transmission arrangement 21 with the same components corresponding to the cover sheets, with the difference that the respective gear wheels 24, 25 and 28, 29 are driven in rotation opposite to the rotation direction 7 of the gear wheels 22, 23, 26, 27, while the rotary speed of all rotating components is identical.

Thus, all cover sheets 11-14 are placed in the same actuating state at the same time simultaneously and with the same speed and all cover sheets 11-14 are closed at the same time in direction R1 or opened in direction R2.

Accordingly, a reversing gear 46, a telescopic coupling 47, the gear wheel 24 with the actuating element 36 and a transverse shaft 48 with the further gear wheel 25 and the actuating element 37 is responsible for the movement of the cover sheet 12.

Correspondingly, a reversing gear 49, a telescopic coupling 50, the gear wheel 28 with the actuating element 40 and a transverse shaft 51 with the further gear wheel 29 and the actuating element 41 is responsible for the movement of the cover sheet 14.

For the organizing of the opposite rotary speed of the rotating components for the movement of the cover sheets 11 and 13 on the one hand and that of the rotating components for the movement of the cover sheets 12 and 14 on the other hand, only the respective reversing gears are installed the other way around. This means that the reversing gears 31 and 43 are installed the other way around to the reversing gears 45, 49.

Moreover, in order to hold the canopy device 1, three cross beams 52, 53 and 54 fashioned as hollow rectangular profiles are provided in the eaves 17-19, extending transversely to the movement direction V. The cross beams 52, 53 and 54 are supported at their respective end regions on either side by a ground structure, such as the truss structure 55, while another opposite ground structure parallel to and at a distance from the truss structure 55 is not shown. In the longitudinal direction of the extensible parallel cross beams 52-54, the canopy device 1 can be lengthened with correspondingly extensible cover sheets 11-14 or transverse shafts and additional girders or have other corresponding components. A lengthening in the direction of movement V with additional rows is also possible. If necessary, additional drive units with corresponding drive shafts may be provided for this.

Along the eaves 17-19 or the cross beams 52-54, these may be designed to collect and carry away rainwater and/or hail in the end regions of the canopy device 1, for example, they may have a roof gutter, which is advantageous for relieving strain on the layout when the canopy 2 is fully or partly closed.

### LIST OF REFERENCE NUMBERS

1 Canopy device

2 Canopy

3 Canopy material

4 Drive unit

5, 6 Row

7-10 Girder

7a, 7b Girder section

8a, 8b Girder section

9a, 9b Girder section

10a, 10b Girder section

11 Cover sheet

11a Section

12-14 Cover sheet

15, 16 Ridge area

17-19 Eaves

20 Electric motor

21 Transmission arrangement

22-29 Gear wheel

30 Drive shaft

31 Reversing gear

32 Telescopic coupling

33 Transverse shaft

34-41 Actuating element

42 Tooth contour

43 Reversing gear

44 Telescopic coupling

45 Transverse shaft

46 Reversing gear

47 Telescopic coupling

48 Transverse shaft

49 Reversing gear

50 Telescopic coupling

51 Transverse shaft

52-54 Cross beam

55 Truss structure

1. A canopy device for providing a canopy made from a flexible canopy material, which can be moved with the device into various actuating states, wherein the device comprises a drive unit for moving the canopy material into the different actuating states, and at least two girders, which define a canopy region and extend in a movement direction of the canopy material and which are spaced apart from each other transversely to the movement direction of the canopy material, wherein the canopy material can be moved from an opened actuating state of the canopy to various actuating states of the canopy material between the at least two girders, so that the canopy material spans at least one section between the girders, wherein the drive unit is fixed in position, and the device further comprises a transmission arrangement and an actuating element able to move along at least one of the girders, which are coordinated such that a driving action can be transmitted from the drive unit to the actuating element, wherein the actuating element is designed for a connection to the canopy material and wherein the actuating element is coupled to a gear wheel of the transmission arrangement which is drivable by the drive unit, wherein the gear wheel interacts with a tooth contour formed along the girder.

2. The canopy device according to claim 1, wherein the transmission arrangement comprises a drive shaft drivable with the drive unit, which is mounted fixed in position.

3. The canopy device according to claim 1, wherein several actuating elements can be driven at the same time with a single drive shaft.

4. The canopy device according to claim 1, wherein the transmission arrangement comprises a telescopic coupling.

5. The canopy device according to claim 1, wherein the transmission arrangement comprises a reversing gear.

6. The canopy device according to claim 2, further comprising a connection segment that engages each time at several positions of the drive shaft, spaced apart from each other in the longitudinal direction of the drive shaft, thereby establishing a driving connection to a corresponding gear wheel.

7. The canopy device according to claim 1, further comprising at least two gear wheels, spaced apart from each other in the direction transverse to the drive shaft, and linked together firm against rotation by a connection element of the transmission arrangement.

8. The canopy device according to claim 1, further comprising an actuating element connected and coordinated with the canopy material such that the canopy material is compressible by a folding process during an opening process of the canopy.

9. The canopy device according to claim 1, wherein at least two actuating elements are provided on one girder, each actuating element being drivable by a corresponding transmission arrangement.

10. The canopy device according to claim 1, wherein the girder is fashioned as a curved longitudinal profile.

11. The canopy device according to claim 1, wherein the girder comprises a first girder section and a second girder section, wherein a corresponding first gear wheel moves along the first girder section and a corresponding second gear wheel moves along the second girder section.

12. The canopy device according to claim 1, wherein several canopy rows are present, arranged alongside each other in the movement direction of the canopy material, each canopy row comprising several girders, spaced apart from each other transversely to the movement direction of the canopy material.
